(19) United States
(12) Patent Application Publication
(10) Pub. No.: US 2012/0096186 A1
(43) Pub. Date: Apr. 19, 2012

(54) Method for Pear to Pear Signal Synchronization and Wireless Communication Device and System Using the Same

(75) Inventors: Yao-Tsung Chang, Taipei Hsien (TW); Chia-Hsien Li, Taipei Hsien (TW); Teng-Yi Chiu, Taipei Hsien (TW); Shun-Chi Chung, Taipei Hsien (TW)

(73) Assignee: WISTRON CORPORATION, New Taipei City (TW)

(21) Appl. No.: 13/116,756

(22) Filed: May 26, 2011

(30) Foreign Application Priority Data
Oct. 14, 2010 (TW) 99135080

(51) Int. Cl. G06F 15/16

(52) U.S. Cl. 709/248

(57) ABSTRACT

A method for P2P signal synchronization and P2P wireless communication device and system using the same. The method includes the following steps. A first P2P wireless communication device having an effective range acts as a master device. At least one second P2P wireless communication device located in the effective range is paired and connected with the first P2P wireless communication device. When the first P2P wireless communication device acts as the master device, the first P2P wireless communication device broadcasts a synchronization signal. After the at least one second P2P wireless communication device receives the synchronization signal, at least one second P2P wireless communication device is switched to the master device and broadcasts the synchronization signal.

This application claims the benefit of Taiwan application Serial No. 99135080, filed Oct. 14, 2010, the subject matter of which is incorporated herein by reference.

### BACKGROUND OF THE INVENTION

1. Field of the Invention

The invention relates in general to a method for signal synchronization and a device and a system using the same, and more particularly to a method for peer to peer (P2P) signal synchronization and P2P wireless communication device and system.

2. Description of the Related Art Internet and wireless communication have played very important roles in the life of the modern human beings. At present, interaction modes of each node over the Internet may be classified into: (1) client/server architecture; (2) peer to peer architecture; and (3) service-oriented architecture.

In the first architecture, a server has to be used and a network system has to be created in advance so that the network service can be used. In the second architecture, all the nodes over the network simultaneously play the roles of clients and servers, and any two nodes can directly share information or exchange contents without through the server. All the nodes may be potential users of the service or the potential providers of the service. So, the peer to peer architecture is adapted to the independent and open distributed Internet application system.

For the wireless communication, the P2P wireless communication technology, such as the bluetooth communication technology, has been widely applied to various modern portable electronic devices. The bluetooth communication technology is a short distance (10 m to 100 m) and low power wireless communication technology, and is adapted to the data exchange between various electronic devices in the small area environment, such as the environment at home, in the office and in the vehicle. It is an important subject in the industry to optimize the network architecture in conjunction with the P2P wireless communication technology so that the electronic devices provide the more diversified functions and are adapted to various daily requirements of the modern human beings.

### SUMMARY OF THE INVENTION

The invention is directed to a method for peer to peer (P2P) signal synchronization, and P2P wireless communication device and system using the same. The P2P wireless communication devices may be synchronized with each other without the network architecture to be created in advance and without the use of the server. The invention has the advantage of saving the bandwidth and the advantage of the highly flexible system architecture.

According to a first aspect of the present invention, a method for P2P signal synchronization is provided. The method includes the following steps. A first P2P wireless communication device, having an effective range, is controlled to act as a master device. At least one second P2P wireless communication device, located in the effective range, is paired and connected with the first P2P wireless communication device. The first P2P wireless communication device broadcasts a synchronization signal when the first P2P wireless communication device acts as the master device. The at least one second P2P wireless communication device is switched to the master device and broadcasts the synchronization signal after the at least one second P2P wireless communication device receives the synchronization signal.

According to a second aspect of the present invention, a peer to peer (P2P) wireless communication device capable of performing P2P signal synchronization is provided. The device includes a P2P wireless communication unit and a control module. The P2P wireless communication unit performs P2P wireless communication with an external environment. The control module controls the P2P wireless communication unit and controls the P2P wireless communication device, having an effective range, to act as a master device. When at least one other P2P wireless communication device is located in the effective range, the P2P wireless communication device is paired and connected with the at least one other P2P wireless communication device. When the P2P wireless communication device acts as the master device, the control module controls the P2P wireless communication device to broadcast a synchronization signal. After the at least one other P2P wireless communication device receives the synchronization signal, the at least one other P2P wireless communication device is switched to the master device and broadcasts the synchronization signal.

According to a third aspect of the present invention, a peer to peer (P2P) wireless communication system capable of performing P2P signal synchronization is provided. The system includes a first P2P wireless communication device and at least one second P2P wireless communication device. The first P2P wireless communication device, having an effective range, acts as a master device. The at least one second P2P wireless communication device located in the effective range is paired and connected with the first P2P wireless communication device. When the first P2P wireless communication device acts as the master device, the first P2P wireless communication device further broadcasts a synchronization signal. After the at least one second P2P wireless communication device receives the synchronization signal, the at least one second P2P wireless communication device is switched to the master device and broadcasts the synchronization signal.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a flow chart showing a method for P2P signal synchronization according to a first embodiment of the invention.

FIG. 2 is a flow chart showing operations of a bluetooth device acting as a master device.

FIG. 3 is a flow chart showing operations of the bluetooth device acting as a slave device.

FIGS. 4A to 4D are schematic illustrations showing an example when a bluetooth system capable of performing P2P signal synchronization is grouping.

FIG. 5 is a flow chart showing operations of the bluetooth device when the signal synchronization is to be performed.

FIGS. 6A to 6D are schematic illustrations showing an example when the bluetooth system capable of performing P2P signal synchronization is performing the signal synchronization.

FIG. 7 is a block diagram showing an example of a P2P wireless communication device capable of performing the P2P signal synchronization of FIG. 1.

FIG. 8 is a flow chart showing a method for P2P signal synchronization according to a second embodiment of the invention.

### DETAILED DESCRIPTION OF THE INVENTION

### First Embodiment

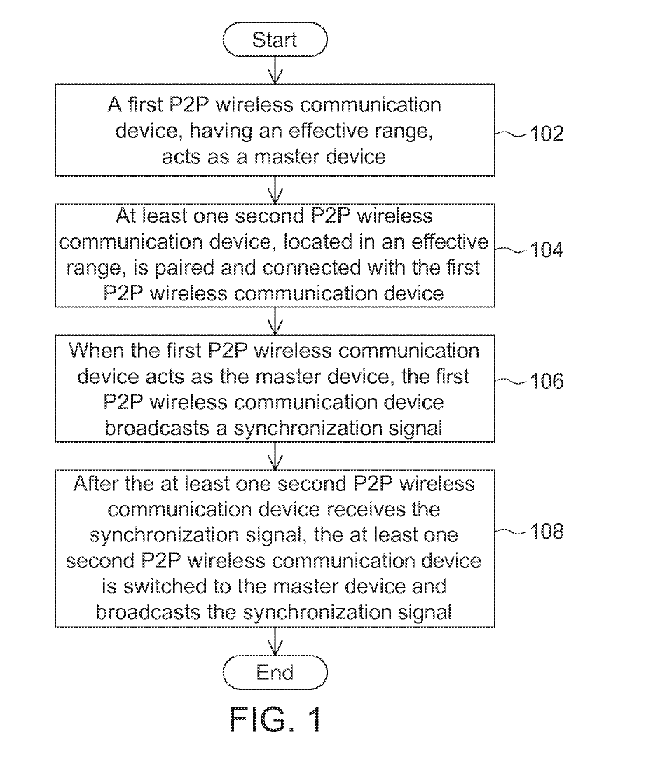

FIG. 1 is a flow chart showing a method for peer to peer (P2P) signal synchronization according to a first embodiment of the invention. First, as shown in step 102, a first P2P wireless communication device, having an effective range, acts as a master device. Next, as shown in step 104, at least one second P2P wireless communication device, located within the effective range, is paired and connected with the first P2P wireless communication device. Then, as shown in step 106, when the first P2P wireless communication device acts as the master device, the first P2P wireless communication device broadcasts a synchronization signal. Thereafter, as shown in step 108, after the at least one second P2P wireless communication device receives the synchronization signal, the at least one second P2P wireless communication device is switched to the master device and broadcasts the synchronization signal.

After the at least one second P2P wireless communication device receives the synchronization signal, the at least one second P2P wireless communication device is synchronized with the first P2P wireless communication device. In addition, the at least one second P2P wireless communication device may further broadcast the synchronization signal so that the other P2P wireless communication device or devices may receive the synchronization signal, and the other P2P wireless communication device or devices may also be synchronized with the first P2P wireless communication device. Thus, multiple P2P wireless communication devices can be synchronized by controlling the P2P wireless communication device, which receives the synchronization signal, to be switched to the master device and to broadcast the synchronization signal. In addition, this embodiment can synchronize all the P2P wireless communication devices by only transmitting the synchronization signal without transmitting a lot of data. Furthermore, because no server has to be used, the architecture and the number of connected P2P wireless communication devices may be adjusted according to the condition, so that this embodiment further has the advantage of the high flexibility of the system architecture.

Illustrations will be made according to the P2P wireless communication device serving as a bluetooth device. However, this embodiment is also adapted to other types of P2P wireless communication devices.

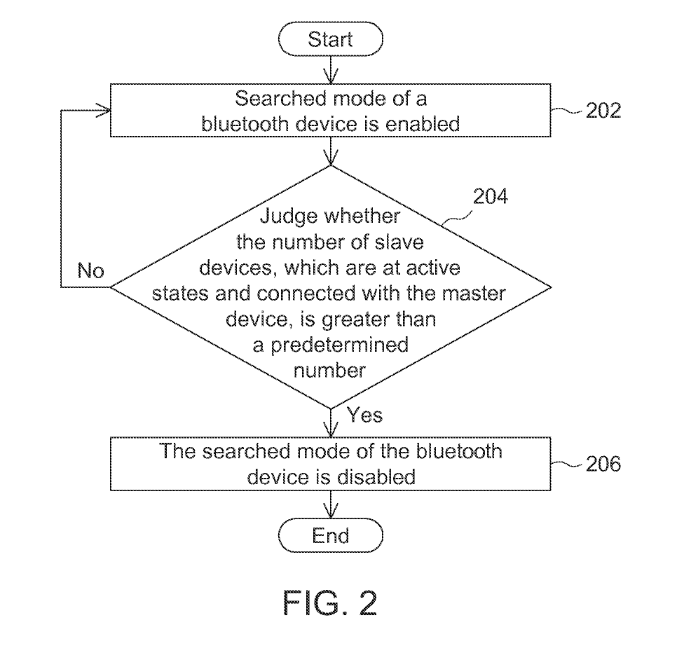

The bluetooth device of this embodiment may be set as either the master device or a slave device. FIG. 2 is a flow chart showing operations of the bluetooth device acting as the master device. As shown in FIG. 2, when the bluetooth device acts as the master device, as shown in step 202, the searched mode of the bluetooth device is enabled. In the effective range of the bluetooth device, the bluetooth device and other bluetooth devices may perform bluetooth wireless communication. The other bluetooth devices located within the effective range can search this bluetooth device to create the connection or link. In the current bluetooth specification, one master device may be connected with at most seven slave devices in active states or 255 slave devices in standby states, for example.

Then, as shown in step 204, it is judged whether the number of slave devices, which are connected to the master device and in the active states, is greater than a predetermined number, such as the number specified by the bluetooth specification. If yes, the process enters step 206; or otherwise the process returns to the step 202. In the step 206, the searched mode of the bluetooth device is disabled and the bluetooth device is no longer connected to other slave devices.

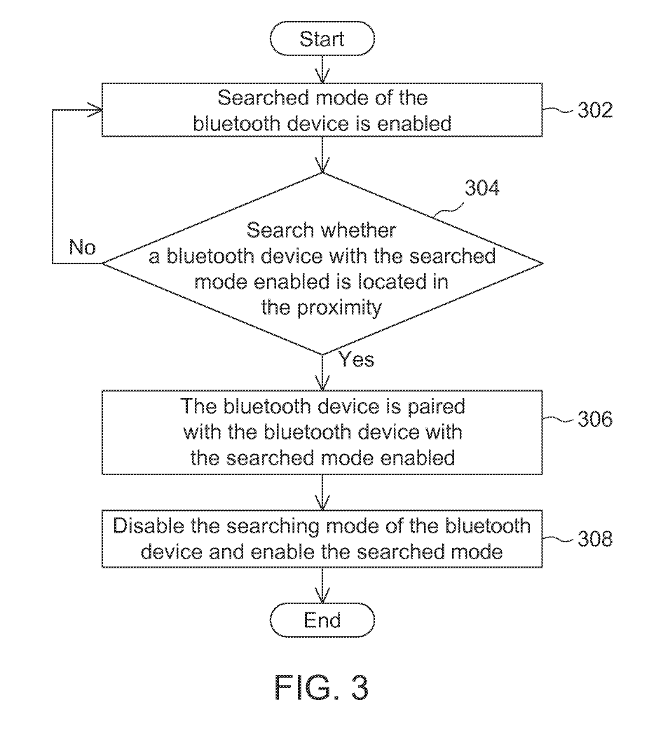

FIG. 3 is a flow chart showing operations of the bluetooth device acting as the slave device. As shown in FIG. 3, when the bluetooth device acts as the slave device, as shown in step 302, the searching mode of the bluetooth device is enabled. Next, in step 304, whether the bluetooth device with the searched mode enabled in the proximity is searched. If not, the process goes back to the step 302; or otherwise the process enters step 306, in which the bluetooth device is paired and connected with the bluetooth device with the searched mode enabled. Thereafter, in step 308, the searching mode of the bluetooth device is disabled, and the searched mode is enabled. That is, the bluetooth device originally acting as the slave device is switched to the master device.

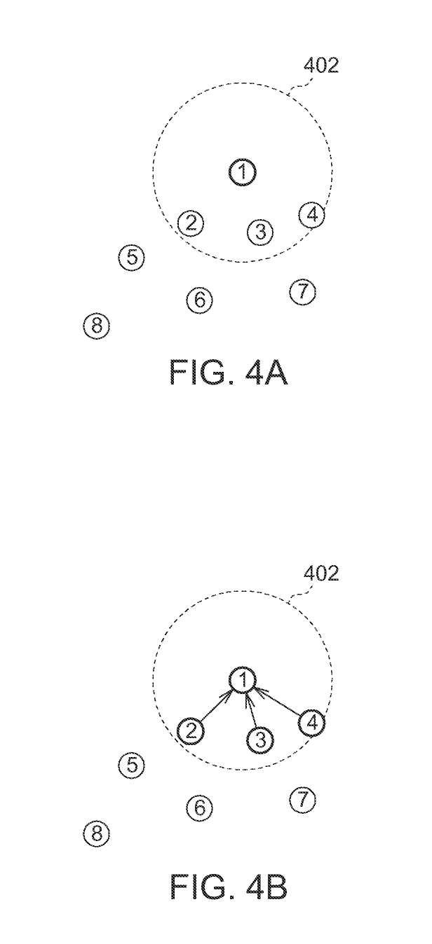

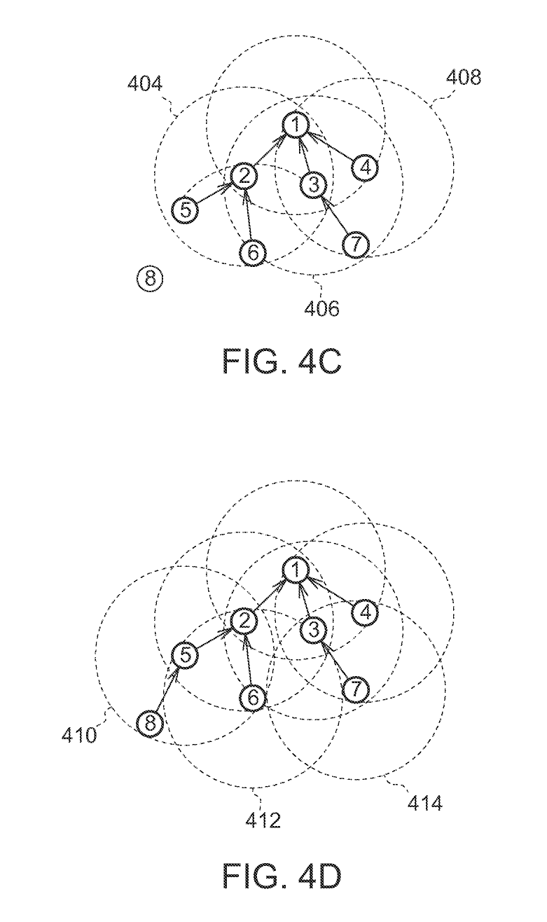

Further details will be described according to one example. FIGS. 4A to 4D are schematic illustrations showing an example when a bluetooth system capable of performing P2P signal synchronization is grouping. As shown in FIGS. 4A to 4D, nodes 1 to 8 represent eight different bluetooth devices, wherein the node 1 may be regarded as the first P2P wireless communication device, and the nodes 2, 3 and 4 may be regarded as the three second P2P wireless communication devices.

First, the node 1 acts as the master device, the searched mode of the node 1 is enabled, and the node 1 has an effective range 402, as shown in FIG. 4A. Because the nodes 2, 3 and 4 are located within the effective range 402, the nodes 2, 3 and 4 firstly act as the slave devices and the searching modes of the nodes 2, 3 and 4 are enabled.

Thereafter, as shown in FIG. 4B, the nodes 2, 3 and 4 are paired with the node 1. In general, two bluetooth devices have to be paired so that the two bluetooth devices can be connected and communicated with each other. The Bluetooth Special Interest Group (SIG) proposes a new specification, Version 2.1, on Jul. 26, 2007, and proposes a new pairing method, security simple pairing (SSP), in the security aspect. The SSP has four operation modes including a numeric comparison mode, a just work mode, an out of band mode and a passkey entry mode. Because the just work mode only needs the user to perform the confirmation operation to finish the pairing, the just work mode is adapted to the environment with the lower security requirement. The pairing of this embodiment may be achieved by, for example, the just work mode of SSP, to decrease the system complexity.

As shown in FIG. 4B, after the nodes 2, 3 and 4 are paired with the node 1, the nodes 2, 3 and 4 are connected to the node 1 to form a bluetooth wireless network for communication. This network formed by the connections between one master device and multiple slave devices is referred to as a piconet.

Thereafter, the nodes 2, 3 and 4 are switched to the master devices and the searched mode. For example, the node 1 may be continuously kept in the mode of the master device. However, this embodiment is not restricted thereto. At this time, as shown in FIG. 4C, the nodes 2, 3 and 4 respectively have effective ranges 404, 406 and 408.

Next, the nodes 5 and 6 located within the effective range 404 are paired with the node 2, and the node 7 located within the effective range 406 is paired with the node 3. At this time, the nodes 2, 5 and 6 form a piconet, and the nodes 3 and 7 form another piconet. After pairing, the nodes 5, 6 and 7 are switched to the master device and the searched mode.

At this time, as shown in FIG. 4D, the nodes 5, 6 and 7 respectively have effective ranges 410, 412 and 414. The node 8 located within the effective range 410 is paired with the node 5, so that the nodes 5 and 8 form a piconet.

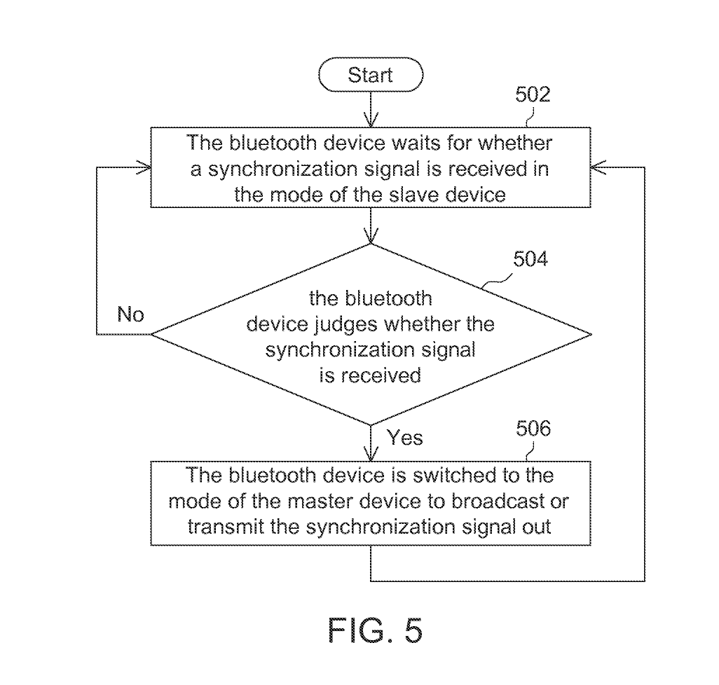

When signal synchronization is to be performed on the bluetooth system constituted by the nodes 1 to 8, the flow chart of the operations of the bluetooth device is shown in FIG. 5. First, as shown in step 502, the bluetooth device waits for the receipt of the synchronization signal in the mode of the slave device. Next, in step 504, the bluetooth device judges whether the synchronization signal is received. If yes, the process enters step 506; or otherwise the process returns to the step 502. In the step 506, the bluetooth device is switched to the mode of the master device to broad or transmit the synchronization signal out.

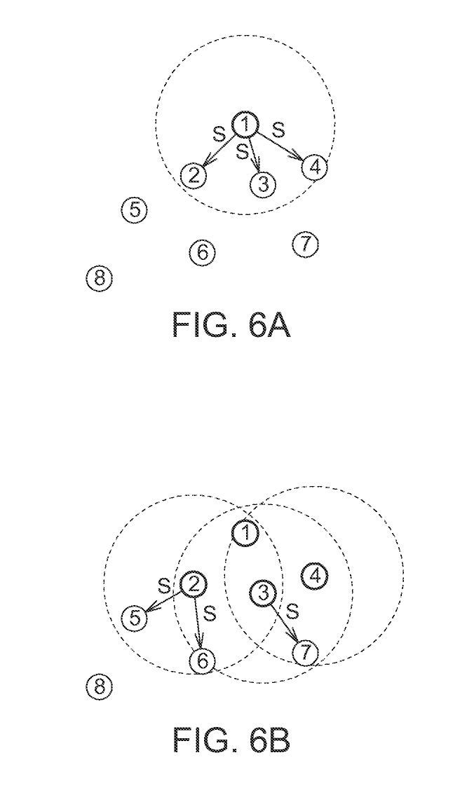

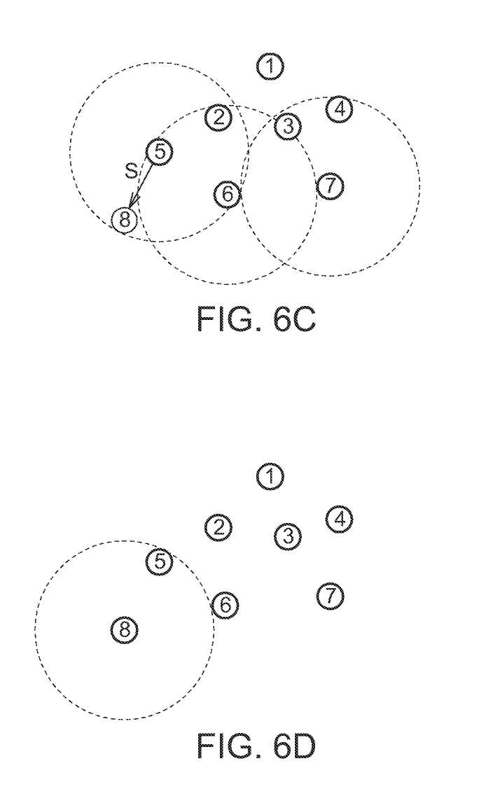

One example will be illustrated in the following. FIGS. 6A to 6D are schematic illustrations showing an example when the bluetooth system capable of performing P2P signal synchronization is performing the signal synchronization. First, as shown in FIG. 6A, the node 1 acts as the master device and broadcasts a synchronization signal S, and the nodes 2, 3 and 4 receive the synchronization signal S.

Next, as shown in FIG. 6B, the nodes 2, 3 and 4 are switched to the master device and broadcast the synchronization signal S. The nodes 5 and 6 receive the synchronization signal S coming from the node 2, while the node 7 receives the synchronization signal S coming from the node 3.

Thereafter, as shown in FIG. 6C, the node 5 is switched to the master device and broadcasts the synchronization signal S. The node 8 receives the synchronization signal S coming from the node 5. Then, as shown in FIG. 6D, the node 8 is switched to the master device and broadcasts the synchronization signal S.

After the node 1 acting as the master device broadcasts the synchronization signal S, the states between the node 1, acting as the master device, and the nodes 2, 3 and 4, acting as the slave devices, are switched to disconnected states. Thereafter, the nodes 2, 3 and 4 are switched to the master devices, and broadcast the synchronization signal S, so that the other nodes in the piconet corresponding to the nodes 2, 3 and 4 can receive the synchronization signal S.

The advantage of switching to the disconnected states is that the states between the node 1 and the nodes 2, 3 and 4 need not to be continuously kept in the connected states so that the resource consumed by the connections may be saved. The connected state only has to be created again when the node 1 has the synchronization signal to be transmitted. In the disconnected state, the nodes 2, 3 and 4 can independently perform the operations to be carried out without being affected by the node 1. The same condition applies to other nodes.

If one node concurrently receives multiple synchronization signals, it is possible to judge which one serves as the main synchronization signal and to neglect the other synchronization signals according to some parameters contained in the synchronization signal. For example, it is possible to judge which synchronization signal is the later synchronization signal outputted by the node 1 among the concurrently received synchronization signals according to the time parameter contained in the synchronization signal, and only to perform the operation corresponding to the later synchronization signal.

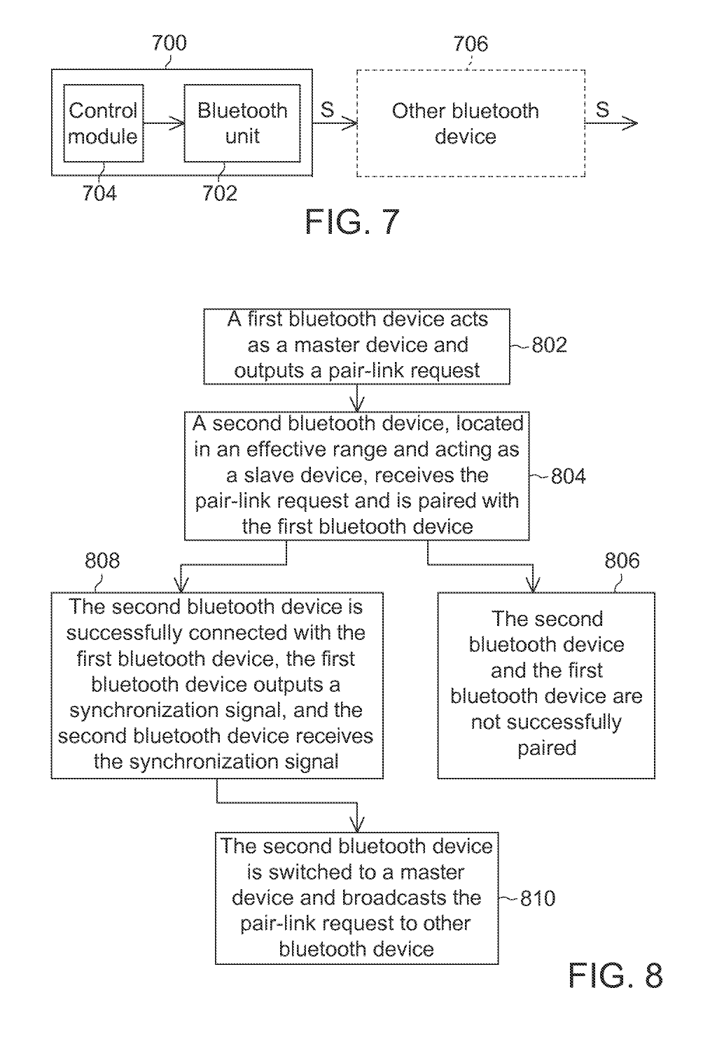

FIG. 7 is a block diagram showing an example of the P2P wireless communication device capable of performing the P2P signal synchronization of FIG. 1. Referring to FIG. 7, the P2P wireless communication device includes a P2P wireless communication unit and a control module. The P2P wireless communication unit performs the P2P wireless communication with the external environment. Illustrations will be made according to the P2P wireless communication device being a bluetooth device 700. The bluetooth device 700 includes a bluetooth unit 702 and a control module 704. The control module 704 controls the bluetooth unit 702, and the bluetooth unit 702 performs the bluetooth wireless communication with the external environment. The control module 704 further controls the bluetooth device 700 to act as the master device. When at least one other bluetooth device 706 is located within the effective range of the bluetooth device, the bluetooth device 700 is paired and connected with the at least one other bluetooth device 706.

When the bluetooth device 700 acts as the master device, the control module 704 controls the bluetooth device 700 to broadcast a synchronization signal. After the at least one other bluetooth device 706 receives the synchronization signal S, the at least one other bluetooth device 706 is switched to the master device and broadcasts the synchronization signal S.

The control module 704 may be achieved by a processor, firmware, or a processor in conjunction with the associated software.

In addition, in another embodiment, after the at least one second P2P wireless communication device receives the synchronization signal, the at least one second P2P wireless communication device may further transmit a receipt acknowledgement message to the first P2P wireless communication device. For example, when the node 2 of FIG. 6A receives the synchronization signal S, the node 2 may further transmit the receipt acknowledgement message to the node 1.

Similarly, after the node 5 of FIG. 6B receives the synchronization signal S, the node 5 may further transmit a receipt acknowledgement message to the node 2, and the node 2 may further transmit the receipt acknowledgement message, corresponding to the node 5, to the node 1, so that the node 1 obtains that the node 5 has indeed received the synchronization signal. Preferably, the nodes 2 and 5 act as the modes of the master devices to transmit the receipt acknowledgement message. The other nodes may also transmit the receipt acknowledgement message in a similar manner so that the node 1 obtains that all nodes have received the synchronization signal. The receipt acknowledgement message may also be accompanied with an identifier code (ID code) of the node to be transmitted, so that the node 1 can identify the received receipt acknowledgement message as being transmitted from which one of the bluetooth devices.

Preferably, the synchronization signal includes a command signal for making the at least one second P2P wireless communication device perform a predetermined operation, which corresponds to a to-be-performed operation requested by the first P2P wireless communication device. For example, the command signal, outputted from the node 1, can make the nodes 2 to 8 perform a predetermined operation, which corresponds to the to-be-performed operation requested by the node 1, so that the nodes 2 to 8 and the node 1 are synchronized in operation. For example, the command signal may also make pages of an electronic document, displayed on the nodes 2 to 8, be the same as the page of the electronic document, displayed on the node 1.

Also, if the nodes 1 to 8 read the same electronic document, then the node 1 can broadcast a command signal indicating going to a predetermined page, so that the nodes 2 to 8 automatically go to the predetermined page and the synchronization in operation can be achieved. If the invention is applied to the teaching, the node 1 is the bluetooth device used by the instructor and the nodes 2 to 8 are bluetooth devices used by the students, then the bluetooth devices of the nodes 2 to 8 can automatically go to the predetermined page when the instructor go to the predetermined page of the electronic document, so that the pages displayed on the bluetooth devices of the students are the same as that displayed on the bluetooth device of the instructor, and the teaching convenience can be significantly enhanced.

The comparison of this embodiment with the conventional computer classroom will be illustrated in the following. In some computer classrooms, teachers directly switch the frames, displayed on the computer screens of the students, to the frame displayed on the screen of the teacher through screen switching devices to facilitate the teaching. The conventional method has to transmit a lot of frame data to the computer screens of the students, and thus occupies a lot of network bandwidths and network resources. In addition, when the computer screens of the students are switched to the frame of the screen of the teacher, the students cannot operate their own computers. When this embodiment is applied to the teaching, only the synchronization signal has to be transmitted between the bluetooth device of the teacher and the bluetooth devices of the students to synchronize the bluetooth devices of the teacher and the student with each other in operation, and display the same page of the electronic document to achieve the desired teaching effect. The bandwidth used thereby is very low, so a lot of network resources may be saved. In addition, after the bluetooth devices of the students are synchronized with the bluetooth device of the teacher, the students still can operate their own bluetooth devices. For example, the student still can use his/her bluetooth device to highlight some key points, to write marks and the like. This embodiment is unlike the conventional method, which has the drawback that the student cannot operate his/her own computer after the frame of the computer screen of the student is switched to the frame of the screen of the teacher.

Furthermore, this embodiment may also be applied to the occasion when books are commonly read, such as the occasion of religious gathering, the moderator may ask the participants to go to a predetermined page for discussion. Using this embodiment can shorten the time for the participants to go to the predetermined page and provide the excellent convenience for the senior or operation retarded person.

The P2P wireless communication devices may be, for example, portable electronic devices, e-book readers, mobile phones, personal digital assistants, notebook computers, hand-held computers or electronic labels. Thus, the P2P wireless communication devices can form a P2P wireless communication system in various environments, so that the P2P wireless communication devices may be synchronized with each other. This embodiment does not need the network to be created in advance, and does not need the server or access point and has the extremely high convenience. In addition, the architecture of the P2P wireless communication system of this embodiment may be very flexible. That is, the number of, the positions of and the connections between the P2P wireless communication devices of the P2P wireless communication may be adjusted at any time. For example, even if the users go outdoors, the users still can use this embodiment to create the required P2P wireless communication system to complete the synchronization.

The synchronization signal may also be a command querying whether the P2P wireless communication device is present, and may be applied to the roll call mechanism of determining whether the members are present in the classroom, or the roll call operation of determining whether the members in a travel team leaded by a tourist guide are in attendance. Each P2P wireless communication device returns a receipt acknowledgement message, so that whether each P2P wireless communication device is in attendance can be judged, and the roll call operation can be finished immediately and conveniently. In addition, when the P2P wireless communication devices of this embodiment are electronic labels, the synchronization signal may be the signal for synchronously updating the contents of the electronic label.

### Second Embodiment

FIG. 8 is a flow chart showing a method for P2P signal synchronization according to a second embodiment of the invention. As shown in FIG. 8, the P2P wireless communication device being the bluetooth device is also illustrated as an example. First, in step 802, a first bluetooth device acts as a master device and outputs a pair-link request. The first bluetooth device has an effective range.

Next, in step 804, a second bluetooth device, acting as a slave device and located within the effective range, receives the pair-link request and is paired with the first bluetooth device. If the pairing is not completed, the process enters step 806, in which the second bluetooth device and the first bluetooth device are not successfully paired. If the pairing is successfully finished, step 808 is performed.

In the step 808, the second bluetooth device and the first bluetooth device are successfully paired and connected with each other. Next, the first bluetooth device outputs a synchronization signal, and the second bluetooth device receives the synchronization signal. At this time, the second bluetooth device has been synchronized with the first bluetooth device. Thereafter, the state between the second bluetooth device and the first bluetooth device is switched to a disconnected state.

Then, in step 810, the second bluetooth device is switched to the master device, and broadcasts the pair-link request to other bluetooth device or devices. After the pairing succeeds, the second bluetooth device broadcasts the synchronization signal out. Thus, the requirement of synchronizing the bluetooth devices, which is the same as that of the first embodiment, may also be achieved. The other technological features and applications of the second embodiment are the same as those of the first embodiment, and detailed descriptions thereof will be omitted.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for peer to peer (P2P) signal synchronization, comprising the steps of:
controlling a first P2P wireless communication device, having an effective range, to act as a master device;
pairing and connecting at least one second P2P wireless communication device, located in the effective range, with the first P2P wireless communication device;
broadcasting a synchronization signal by the first P2P wireless communication device when the first P2P wireless communication device acts as the master device; and
switching the at least one second P2P wireless communication device to the master device and broadcasting the synchronization signal after the at least one second P2P wireless communication device receives the synchronization signal.

2. The method according to claim 1, wherein after the first P2P wireless communication device broadcasts the synchronization signal, a state between the first P2P wireless communication device and the at least one second P2P wireless communication device is switched to a disconnected state.

3. The method according to claim 1, wherein the synchronization signal comprises a command signal for making the at least one second P2P wireless communication device perform a predetermined operation corresponding to a to-be-performed operation requested by the first P2P wireless communication device.

4. The method according to claim 3, wherein the command signal makes a page of an electronic document, displayed on the at least one second P2P wireless communication device, be the same as a page of the electronic document, displayed on the first P2P wireless communication device.

5. The method according to claim 1, wherein after the at least one second P2P wireless communication device receives the synchronization signal, the at least one second P2P wireless communication device transmits a receipt acknowledgement message to the first P2P wireless communication device.

6. The method according to claim 1, wherein the step of pairing is achieved using a just work mode of security simple pairing (SSP).

7. A peer to peer (P2P) wireless communication device capable of performing P2P signal synchronization, the device comprising:
a P2P wireless communication unit for performing P2P wireless communication with an external environment; and
a control module for controlling the P2P wireless communication unit and controlling the P2P wireless communication device, having an effective range, to act as a master device,
wherein when at least one other P2P wireless communication device is located in the effective range, the P2P wireless communication device is paired and connected with the at least one other P2P wireless communication device;
wherein when the P2P wireless communication device acts as the master device, the control module controls the P2P wireless communication device to broadcast a synchronization signal; and
wherein after the at least one other P2P wireless communication device receives the synchronization signal, the at least one other P2P wireless communication device is switched to the master device and broadcasts the synchronization signal.

8. The device according to claim 7, wherein after the P2P wireless communication device broadcasts the synchronization signal, a state between the P2P wireless communication device and the at least one other P2P wireless communication device is switched to a disconnected state.

9. The device according to claim 7, wherein the synchronization signal comprises a command signal for making the at least one other P2P wireless communication device perform a predetermined operation corresponding to a to-be-performed operation requested by the P2P wireless communication device.

10. The device according to claim 9, wherein the command signal makes a page of an electronic document, displayed on the at least one other P2P wireless communication device, be the same as a page of the electronic document, displayed on the P2P wireless communication device.

11. The device according to claim 7, wherein after the at least one other P2P wireless communication device receives the synchronization signal, the at least one other P2P wireless communication device transmits a receipt acknowledgement message to the P2P wireless communication device.

12. The device according to claim 7, wherein the P2P wireless communication device is paired with the at least one other P2P wireless communication device using a just work mode of security simple pairing (SSP).

13. The device according to claim 7, wherein the P2P wireless communication device is a portable electronic device, an e-book reader, a mobile phone, a personal digital assistant, a notebook computer, a hand-held computer or an electronic label.

14. A peer to peer (P2P) wireless communication system capable of performing P2P signal synchronization, the system comprising:
a first P2P wireless communication device; and
at least one second P2P wireless communication device;
wherein the first P2P wireless communication device, having an effective range, acts as a master device;
wherein the at least one second P2P wireless communication device located in the effective range is paired and connected with the first P2P wireless communication device;
wherein when the first P2P wireless communication device acts as the master device, the first P2P wireless communication device further broadcasts a synchronization signal;
wherein after the at least one second P2P wireless communication device receives the synchronization signal, the at least one second P2P wireless communication device is switched to the master device and broadcasts the synchronization signal.

15. The system according to claim 14, wherein after the first P2P wireless communication device broadcasts the synchronization signal, a state between the first P2P wireless communication device and the at least one second P2P wireless communication device is switched to a disconnected state.

16. The system according to claim 14, wherein the synchronization signal comprises a command signal for making the at least one second P2P wireless communication device perform a predetermined operation corresponding to a to-be-performed operation requested by the first P2P wireless communication device.

17. The system according to claim 16, wherein the command signal makes a page of an electronic document, displayed on the at least one second P2P wireless communication device, be the same as a page of the electronic document, displayed on the first P2P wireless communication device.

18. The system according to claim 14, wherein after the at least one second P2P wireless communication device receives the synchronization signal, the at least one second P2P wireless communication device transmits a receipt acknowledgement message to the first P2P wireless communication device.

19. The system according to claim 14, wherein the at least one second P2P wireless communication device is paired with the first P2P wireless communication device using a just work mode of security simple pairing (SSP).

20. The system according to claim 14, wherein the first P2P wireless communication device and the at least one second P2P wireless communication device are portable electronic devices, e-book readers, mobile phones, personal digital assistants, notebook computers, hand-held computers or electronic labels.
